(19) United States
(12) Patent Application Publication
(10) Pub. No.: US 2013/0135807 A1
(43) Pub. Date: May 30, 2013

(54) ELECTRONIC DEVICE

(71) Applicants: YUAN-MING WANG, Shenzhen City (CN); NA WANG, Shenzhen City (CN); WEI LIU, Shenzhen City (CN); HE-LI WANG, Shenzhen City (CN)

(72) Inventors: YUAN-MING WANG, Shenzhen City (CN); NA WANG, Shenzhen City (CN); WEI LIU, Shenzhen City (CN); HE-LI WANG, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/517,677

(22) Filed: Jun. 14, 2012

(30) Foreign Application Priority Data
Nov. 30, 2011 (CN) 201110389610.1

(51) Int. Cl. G06F 1/16

(52) U.S. Cl. 361/679.02

(57) ABSTRACT

An electronic device includes a main body, a cover rotatably coupled to the main body, and at least one electrical cable. The main body defines a receiving space and a through hole communicating with the receiving space. The cover defines an accommodation space and an aperture communicating with the accommodation space. The aperture corresponds to the through hole, and the electrical cable is capable of extending directly from the cover to the main body by passing through the through hole and the aperture.

### BACKGROUND

1. Technical Field

The present disclosure relates to an electronic device having a main body and a cover rotatably coupled to the main body and the electrical connection between them.

2. Description of Related Art

An electronic device, such as DVD player has a main body, a cover, and a hinge arranged on the main body for rotatably connecting the cover to the main body. The main body accommodates circuit board, DVD drive and other components. A display and a plurality of electronic components are mounted to the cover. The electronic device further includes a plurality of electrical cables for electrically connecting the display and the electronic components mounted to the cover to the circuit board accommodated in the main body. The hinge may define a through hole extending in a direction parallel to the rotational axis of the hinge, and the electrical cables from the cover can pass through the hole to extend into the main body. However, it is waste of time and also inconvenient to assembly the electrical cables by passing the cables through the hole.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the three views.

FIG. 1 is a partial perspective view of an electronic device in accordance with an exemplary embodiment.

FIG. 2 is a partially disassembled view of the electronic device of FIG. 1.

FIG. 3 is a cross-sectional view taken along line III-III of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

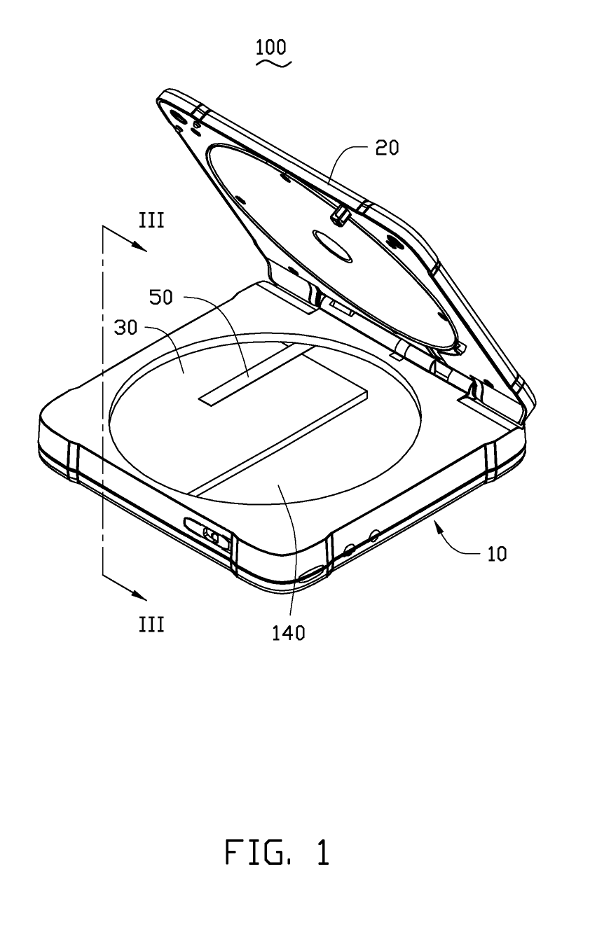

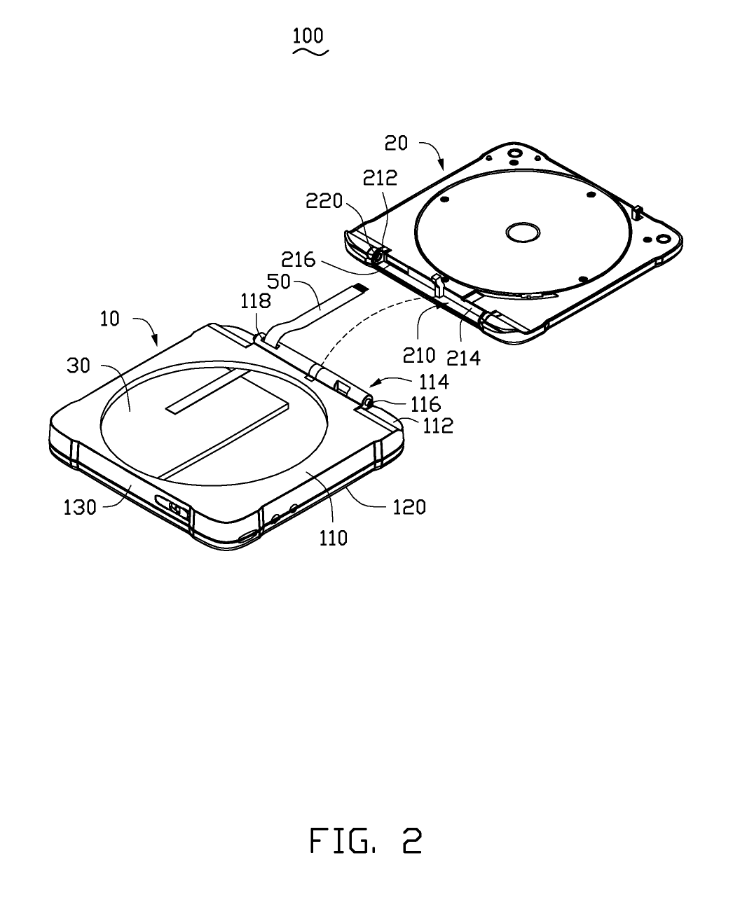

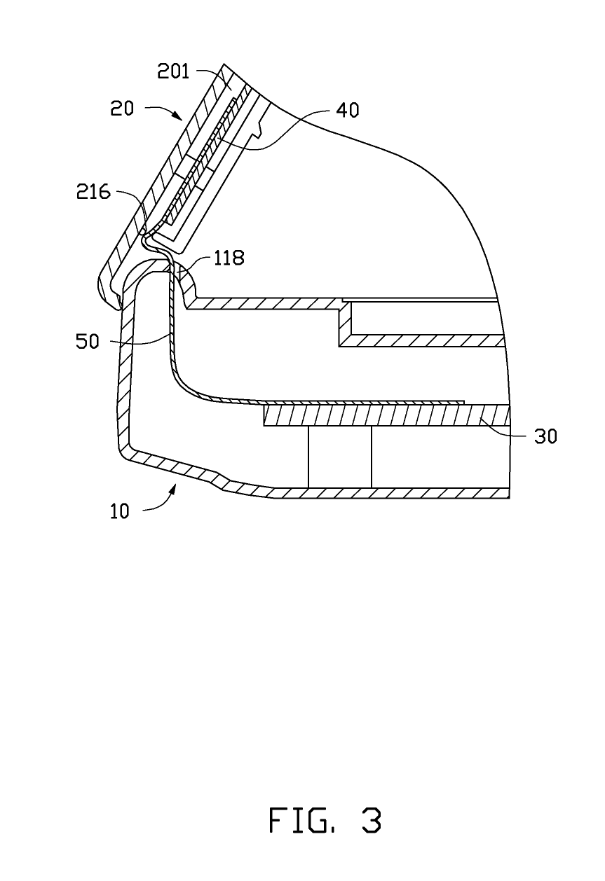

Referring to FIGS. 1-2, an electronic device 100 in accordance with an embodiment is shown. The electronic device 100 includes a main body 10, a cover 20 coupled to the main body 10, a first electronic member 30 housed in the main body 10, a second electronic member 40 (see FIG. 3) received in the cover 20, and an electrical cable 50 for electrically connecting the first electronic member 30 with the second electronic member 40. In the embodiment, the electronic device 100 is portable DVD player, the main body 10 is the host of the DVD disc, and the first electronic member 30 is the motherboard of the DVD player, the second electronic member 40 is a drive circuit of a display (not shown) mounted on the cover 20.

The main body 10 is substantially rectangular. The main body 10 includes a top wall 110, a bottom wall 120 and four sidewalls 130. The top wall 110, the bottom wall 120 and the sidewalls 130 cooperatively define a receiving space 140 for receiving the first electronic member 30, the DVD driver, a power supply and other electronic components (not shown). The top wall 110 includes four rims, the rim where the cover 20 connects with the main body 10 is referred to herein as a first rim 112. A flange 114 protrudes from the first rim 112 and extends in a direction parallel to the first rim 112. Two pivot rods 116 are secured to opposite ends of the flange 114. The pivot rods 116 are coaxial and are parallel to the first rim 112. The flange 114 defines a through hole 118. The through hole 118 is arranged at the top of the flange 114 and communicates with the receiving space 140. The through hole 118 in the embodiment is substantially elongated.

The cover 20 is substantially rectangular and is coupled to the pivot rods 116. The cover 20 defines an accommodating space 201 (see FIG. 3) for receiving the second electronic member 40. An end of the cover 20 coupled to the pivot rods 116 defines a recess 210. The recess 210 corresponds to and receives the flange 114 when the cover 20 is closed and covers the main body 10. The recess 210 includes opposite side portions 212 and a bottom portion 214 sandwiched between the side portions 212. Each side portion 212 defines a pivot hole 220. The pivot holes 220 correspond to and receive a pivot rod 116 each. The bottom portion 214 defines an aperture 216 corresponding to the through hole 118. The aperture 216 communicates with the accommodating space 201.

The electrical cable 50 is a flexible wire and is substantially strip shaped in the embodiment. The size of the electrical cable 50 is less than the size of the through hole 118 and the aperture 216.

Referring to FIG. 3, in assembly, firstly, an end of the electrical cable 50 is electrically connected to the second electronic member 40, the other end of the electrical cable 50 passes through the aperture 216 and the through hole 118 and is electrically connected to the first electronic member 30. Secondly, the flange 114 is received in the recess 210 with the pivot rods 116 in the pivot holes 210, and the cover 20 is thus coupled to the main body 10.

By means of the through hole 118 defined in the main body 10 and the aperture 216 defined in the cover 20, the electrical cable 50 can directly extend from the cover 20 to the main body 10, without a break, and without any intervening connections, and the removal and refitting of the electrical cable 50 is easy and convenient.

It is to be understood, even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a main body defining a receiving space and a through hole communicating with the receiving space;
a cover rotatably coupled to the main body, the cover defining an accommodate space and an aperture communicating with the accommodate space; and
at least one electrical cable;
wherein the aperture corresponds to the through hole, and the at least one electrical cable is capable of extending from the cover to the main body by passing through the through hole and the aperture.

2. The electronic device of claim 1, further comprising a first electronic member received in the receiving space and a second electronic member received in the accommodating space, wherein the first electronic member is electrically connected to the second electronic member by the at least one electrical cable.

3. The electronic device of claim 1, wherein two pivot rods are secured to a first rim of the main body, the pivot rods are coaxial.

4. The electronic device of claim 3, wherein the cover is rotatably coupled to the pivot rods.

5. The electronic device of claim 3, wherein the through hole is arranged between the pivot rods.

6. The electronic device of claim 3, wherein a flange protrudes from the first rim of the main body, and the pivot rods are secured to opposite ends of the flange.

7. The electronic device of claim 6, wherein the through hole is defined at the top portion of the flange.

8. The electronic device of claim 6, wherein an end of the cover coupled to the pivot rods defines a recess for receiving the flange when the cover covers the main body.

9. The electronic device of claim 8, wherein the recess comprises opposite side portions and a bottom portion arranged between the side portions, the side portions defines two pivot holes for rotatably receiving the pivot rods.

10. The electronic device of claim 8, wherein the aperture is defined at the bottom portion.

11. The electronic device of claim 1, wherein the size of the at least one electrical cable is less than the size of the through hole and the aperture.

12. The electronic device of claim 1, wherein the at least one electrical cable is a flexible wire and is substantially strip shaped.
